(19) United States
(12) Patent Application Publication
(10) Pub. No.: US 2018/0319924 A1
(43) Pub. Date: Nov. 8, 2018

(54) OPTICAL RESIN COMPOSITION HAVING HIGH IMPACT RESISTANCE, HEAT RESISTANCE AND REFRACTIVITY AND OBTAINED BY APPLYING ORGANIC-INORGANIC HYBRID, AND PREPARATION METHOD THEREOF

(71) Applicant: Jiangsu Qianyuan New Material Technology Co. Ltd., Zhenjiang (CN)

(72) Inventors: Jianping QIAN, Zhenjiang (CN); Jixin ZOU, Zhenjiang (CN); Jionggui LIU, Zhenjiang (CN)

(21) Appl. No.: 15/774,227

(22) PCT Filed: Jun. 15, 2017
(86) PCT No.: PCT/CN2016/108282

§ 371 Date: May 7, 2018

(30) Foreign Application Priority Data
Dec. 8, 2015 (CN) 201510893873.4

(51) Int. Cl. C08G 18/38; C08G 18/75; C08K 13/02; G02B 1/04

(52) U.S. Cl. CPC C08G 18/38; G02B 1/04; C08K 13/02; C08G 18/75

(57) ABSTRACT

The present invention relates to an optical resin composition having high impact resistance, heat resistance and refractivity and obtained by applying organic-inorganic hybrid, and a preparation method thereof. The optical resin composition is prepared from the following components by mass percent: 100% of a mixture A, 0.1-5% of an inorganic material, 0.05-6% of an ultraviolet absorber, 0.01-5% of a mold release agent, 0.01-5% of a polymerization initiator and 0.03-2% of a color regulator. The optical resin composition of the present invention can be used to prepare optical resin lenses characterized by light mass, easy formability, easy dyeability, high transparency, and high Abbe number, as well as high impact resistance, high heat resistance and high bending rate after surface coating.

### TECHNICAL FIELD

The present invention relates to an optical resin composition having high impact resistance, heat resistance and refractivity and obtained by applying organic-inorganic hybrid, and a preparation method thereof, and belongs to the field of optical resin material technology.

### BACKGROUND

Compared with ordinary glass lenses, optical resin lenses are widely used in the market because of their light mass, easy dyeability and excellent impact resistance. In order to enable lenses to block scattering light and achieve high light transmittance, multiple times of coating (SIO₂, ZRO₂, etc.) shall be conducted on the surfaces of both sides of the lenses, but the strength of coated lenses will be significantly reduced. Such kind of problem has taken place in mildly bent lenses, intermediately bent lenses, highly bent lenses and preliminary highly bent lenses.

In a drop ball test as defined by FDA, a standard steel ball (16.8 g) was dropped from a height of 127 cm upon a multi-coated optical resin lens (center thickness 1.2 mm) made from high molecular diallyl 2,2′-oxydiethyl dicarbonate with mild bending performance in the prior art, and the lens center was broken.

Highly bent lenses in the prior art are mainly made from a mixture of dialkyl isophthalic acid and diallyl 2,2′-oxydiethyl dicarbonate added to dialkyl isophthalate polyol. In order to increase the strength of the lenses, ethanol is added to dialkyl isophthalic acid, but modified diallyl isophthalate is used to make bent resin lenses (center thickness 1.2 mm), which failed to pass repeated coating tests as defined by FDA. Moreover, in order to achieve the purpose of reinforcing pentaerythritol tetra(3-mercaptopropionate) lenses, alcohol is added to isocyanate and cyanate to make optical resin lenses with excellent strength, but the viscosity of the resin lenses is very high, so that the injection is very slow, a lot of flue gas is produced in liquid flow, and finally the reject ratio of the produced optical resin lenses is very high.

Highly bent and preliminarily highly bent lenses in the prior art are made from diisocyanate and a polymer of 1,2-dimercapto and ethyl-3-mercapto propane, and their bending rate is improved using an aliphatic isocyanic acid, 1,2-dimercapto and ethyl-3-mercapto propane, and pentaerythritol tetra(3-mercaptopropionate). This method does improve the bending rate, but finally the multi-coated lenses fail to pass FDA test. Polycarbonate lenses made by injection molding have improved strength after multiple coating, but have reduced heat resistance and severe deformation of the lens center.

For lenses with impact resistance in the prior art, highly reinforced optical lenses are developed using isocyanate, cyanate, pentaerythritol tetra(3-mercaptopropionate) and a mixture of pentaerythritol tetra(3-mercaptopropionate) and pentaerythritol tetramethacrylate, and intermediately bent lenses made using this method have high strength, but highly bent lenses made using this method fail to have high strength, have weak heat resistance and have very high reject ration after being coated, like polycarbonate resin lenses. Central areas of multi-coated lenses are severely deformed.

Thus, preparing an optical resin composition having high impact resistance, heat resistance and refractivity to make optical resin lenses is of great significance for improving the properties thereof.

### SUMMARY

An object of the present invention is to, in view of the defects of the prior art, provide an optical resin composition having high impact resistance, heat resistance and refractivity and obtained by applying organic-inorganic hybrid, and a preparation method thereof. The optical resin composition of the present invention can be used to prepare optical resin lenses characterized by light mass, easy formability, easy dyeability, high transparency, and high Abbe number, as well as high impact resistance, high heat resistance and high bending rate after surface coating.

The present invention is achieved by the following technical solutions:

An optical resin composition having high impact resistance, heat resistance and refractivity and obtained by applying organic-inorganic hybrid is prepared from the following components by mass percent:

| | |
|---|---|
| Mixture A | 100% |
| Inorganic material | 0.1-5% |
| Ultraviolet absorber | 0.05-6% |
| Mold release agent | 0.01-5% |
| Polymerization initiator | 0.01-5% |
| Color regulator | 0.03-2%; |

where the mixture A is obtained by mixing a mixture B and an inorganic material, the inorganic material is 0.1-5% mass percent of the mixture B, and the inorganic material is one of TiO₂, SiO₂ and Zn(OH)₂;

the mixture B is obtained by mixing 30-60% mass percent of a mixture C and 40-70% mass percent of a mixture D;

the mixture C is obtained by mixing isocyanate, cyanate and hydrogenated diphenylmethane diisocyanate, or any two thereof, where the molar ratio of the isocyanate to the cyanate is 1:0.3, the molar ratio of the isocyanate to the hydrogenated diphenylmethane diisocyanate is 1:0.4, and the molar ratio of the hydrogenated diphenylmethane diisocyanate to the cyanate is 1:(0.1-0.5);

the mixture D is obtained by mixing pentaerythritol tetra(3-mercaptopropionate) and 2,3-bisthio(2-mercapto)-1-propanethiol, where the molar ratio of the pentaerythritol tetra(3-mercaptopropionate) to the 2,3-bisthio(2-mercapto)-1-propanethiol is (0.3-1):1;

the ultraviolet absorber is one of 2-(2′-hydroxy-5-methylphenyl)-2H-benzotriazole, 2-(2′-hydroxy-3′,5′-di-tert-butyl-phenyl)-5-chloro-2H-benzotriazole, 2-(2′-hydroxy-3′-tert-butyl-5′-methylphenyl)-5-chloro-2H-benzotriazole, 2-(2′-hydroxy-3′,5′-di-tert-pentylphenyl-T-)-2H-benzotriazole, 2-(2′-hydroxy-3′,5′-di-tert-butyl-tert-phenyl)-2H-benzotriazole, 2-(2′-hydroxy-5′-tert-butylphenyl)-2H-benzotriazole, 2-(2′-hydroxy-5′-tert-octylphenol)-2H-benzotriazole, 2,4-dihydroxy benzophenone, 2-hydroxy-4-methoxy benzophenone, 2-hydroxy-4-octyloxy benzophenone, 4-dodecyloxy-2-hydroxy benzophenone, 2,2′,4,4′-tetrahydroxy benzophenone, and 2,2′-dihydroxy-4,4′-dimethoxy benzophenone;

the mold release agent is an acid phosphate, where the acid phosphate includes acid isopropyl phosphate, acid diisopropyl phosphate, acid butyl phosphate, acid octyl phosphate, acid diisodecyl phosphate, acid tridecyl phosphate and acid bistridecyl phosphate; and

the polymerization initiator is a tin-based chemical product having an amino group, and the tin-based compound includes dibutyltin dilaurate, bis(trichloromethyl) carbonate, benzotriazole; stannous octoate, dibutyltin dilaurate, stannic fluoride, stannic chloride, stannic bromide, stannic iodide, methyltin trichloride, butyltin trichloride, dimethyltin dichloride, dibutyltin dichloride, trimethyltin chloride, tributyltin chloride, triphenyltin chloride and dibutyltin sulfide.

In the foregoing optical resin composition having high impact resistance, heat resistance and refractivity and obtained by applying organic-inorganic hybrid, the molar ratio of the hydrogenated diphenyl methane diisocyanate to the cyanate is preferably 1:(0.2-0.4).

In the foregoing optical resin composition having high impact resistance, heat resistance and refractivity and obtained by applying organic-inorganic hybrid, the liquid phase viscosity of the optical resin composition at 20° C. is 15 to 180 cps.

A preparation method of the foregoing optical resin composition having high impact resistance, heat resistance and refractivity and obtained by applying organic-inorganic hybrid includes the following steps:

obtaining a mixture B by mixing 30-60% mass percent of a mixture C and 40-70% mass percent of a mixture D in a nitrogen-filled reactor; obtaining a mixture A by adding an inorganic material (0.1-5% mass percent of the mixture B); adding an ultraviolet absorber (0.05-6% mass percent of the mixture D), a mold release agent (0.01-5%), a polymerization initiator (0.01-5%) and a color regulator (0.03-2%); stirring under reduced pressure for 2-5 hours; and terminating the reaction and defoaming under reduced pressure.

The foregoing optical resin composition having high impact resistance, heat resistance and refractivity and obtained by applying organic-inorganic hybrid can be used to prepare optimal resin lenses, and a preparation method thereof includes the following steps:

injecting the optical resin composition into a mold and putting in a drying oven at a controlled temperature of 33-37° C. for 2 hours; heating to 38-42° C. in 5 hours, heating to 115-130° C. in 12 hours and keeping at the temperature for 2 hours; cooling to 60-80° C. in 2 hours; removing the mold; carrying out thermal treatment at 105-135° C. for 1.5-3 hours; and carrying out hardening treatment and multi-layer coating treatment.

The beneficial effects of the present invention are:

The optical resin composition prepared in the present invention has a liquid phase refractivity (nD) of 1.430-1.635, and a liquid phase specific gravity of 1.02-1.35; and the optical resin lens has a solid phase refractivity (nD) of 1.535-1.675, an Abbe number of 35-48, a solid phase specific gravity of 1.12-1.45, excellent impact resistance and heat resistance, as well as excellent light mass, formability, dyeability, transparency and high Abbe number. After surface hardening treatment and multi-layer coating, the lens can maintain excellent characteristics, and can be applied to all walks of life using the sprayed coatings of a plurality of properties.

### DETAILED DESCRIPTION

The embodiments of the invention are further illustrated in conjunction with the examples below:

### Embodiment 1

An optical resin composition having high impact resistance, heat resistance and refractivity and obtained by applying organic-inorganic hybrid can be used to prepare optimal resin lenses, and a preparation and application method thereof includes the following steps:

(1) 176.5 g of hydrogenated diphenylmethane diisocyanate (H12MDI), 86.9 g of a cyanate (HDI), 150 g of pentaerythritol tetra(3-mercaptopropionate), 100 g of 2,3-bis(thio(2-mercaptoethyl))-1-n-propanethiol (MDODT), 0.5 g of SiO₂, 20 g of an ultraviolet absorber 2-(2′-hydroxy-3′,5′-di-tert-butyl-tert-phenyl)-5-chloro-2H-benzotriazole (HBCBT), 0.2 g of a mold release agent acid butyl phosphate (BP), 1.2 g of a polymerization initiator bis(trichloromethyl) carbonate (BTC), 20 ppm of 1% color regulator 1-hydroxy-4-(p-toluidino)anthraquinone (HTAQ), and 10 ppm of PRD were put into a reactor and stirred under reduced pressure under the protection of nitrogen for 2 hours, and then a composition was obtained after the reaction was stopped;

(2) the composition injected into a glass mold (refractivity −6.00) was dried in a circulating drying oven at 35° C. for 2 hours, heated to 40° C. in 3 hours, heated to 130° C. in 12 hours and kept at this temperature for 2 hours, and cooled to 70° C. in 2 hours; the reinforced resin was taken out from the mold, which was an optical lens with a center thickness of 1.2 mm and a diameter of 75 mm;

(3) the optical lens was subject to thermal treatment at 130° C. for 2 hours after ultrasonic washing with an alkali solution; and

(4) after hardening solution erosion and heat curing treatment, the optical lenses obtained in step (3) was sprayed with monox, zirconia, monox, ITO, zirconia, monox, zirconia, water film (fluoropolymer), etc. on the surface of both sides.

### Embodiment 2

A preparation and application method of an optical resin composition having high impact resistance, heat resistance and refractivity and obtained by applying organic-inorganic hybrid includes the following steps:

176.5 g of hydrogenated diphenylmethane diisocyanate (H12MDI), 86.9 g of a cyanate (HDI), 150 g of pentaerythritol tetra(3-mercaptopropionate) (PETMP), 100 g of 2,3-bis(thio(2-mercaptoethyl))-1-n-propanethiol (MDODT), 0.5 g of TiO₂, 20 g of an ultraviolet absorber 2-(2′-hydroxy-3′,5′-di-tert-butyl-tert-phenyl)-5-chloro-2H-benzotriazole (HBCBT), 0.2 g of a mold release agent acid butyl phosphate (BP), 1.2 g of a polymerization initiator bis(trichloromethyl) carbonate (BTC), 20 ppm of 1% color regulator 1-hydroxy-4-(p-toluidino)anthraquinone (HTAQ), and 10 ppm of PRD were put into a reactor and stirred under reduced pressure under the protection of nitrogen for 2 hours, and then a composition was obtained after the reaction was stopped.

### Embodiment 3

A preparation and application method of an optical resin composition having high impact resistance, heat resistance and refractivity and obtained by applying organic-inorganic hybrid includes the following steps:

176.5 g of hydrogenated diphenylmethane diisocyanate (H12MDI), 86.9 g of a cyanate (HDI), 150 g of pentaerythritol tetra(3-mercaptopropionate) (MDODT), 100 g of 2,3-bis(thio(2-mercaptoethyl))-1-n-propanethiol (MDODT), 0.5 g of Zn(OH)₂, 20 g of an ultraviolet absorber 2-(2′-hydroxy-3′,5′-di-tert-butyl-tert-phenyl)-5-chloro-2H-benzotriazole (HBCBT), 0.2 g of a mold release agent acid butyl phosphate (BP), 1.2 g of a polymerization initiator bis(trichloromethyl) carbonate (BTC), 20 ppm of 1% color regulator 1-hydroxy-4-(p-toluidino)anthraquinone (HTAQ), and 10 ppm of PRD were put into a reactor and stirred under reduced pressure under the protection of nitrogen for 2 hours, and then a composition was obtained after the reaction was stopped.

### Embodiment 4

A preparation and application method of an optical resin composition having high impact resistance, heat resistance and refractivity and obtained by applying organic-inorganic hybrid includes the following steps:

181.4 g of hydrogenated diphenylmethane diisocyanate (H12MDI), 89.4 g of a cyanate (HDI), 130 g of pentaerythritol tetra(3-mercaptopropionate) (PETMP), 100 g of 2,3-bis(thio(2-mercaptoethyl))-1-n-propanethiol (MDODT), 0.5 g of Zn(OH)₂, 20 g of an ultraviolet absorber 2-(2′-hydroxy-5-methylphenyl)-2H-benzotriazole (HMBT), 0.2 g of a mold release agent acid tridecyl phosphate (TDP), 1.2 g of a polymerization initiator bis(trichloromethyl) carbonate (BTC), 20 ppm of 1% color regulator 1-hydroxy-4-(p-toluidino)anthraquinone (HTAQ), and 10 ppm of PRD were put into a reactor and stirred under reduced pressure under the protection of nitrogen for 2 hours, and then a composition was obtained after the reaction was stopped.

Optical resin lens can be obtained in embodiment 2, embodiment 3 or embodiment 4 as per steps (2), (3) and (4) in embodiment 1, and be tested for the following physical properties:

1. refractivity and Abbe number: determined using a Delin Abbe refractometer of Atacota Co 1T;

2. light transmittance: determined using a spectrophotometer;

3. specific weight: calculated according to the volume and mass of the lens measured using a drainage method;

4. heat resistance: determined by Swiss Mettler TOLEDO (DSC-1 and TGA temperature);

5. bubble: as provided in embodiment 1, after the resin is cooled after heat-reinforcing treatment in a mold, ◯ is denoted if there is no bubble at the center of 10 lenses, Δ is denoted if there are bubbles in 1 to 3 lenses, or × is denoted if there are bubbles in more than 4 lenses;

6. impact resistance: a free fall test was conducted by dropping a steel ball upon the center of a lens after hardening treatment and multi-layer coating treatment. The test in which a steel ball weighing 72 g was dropped from a height of 127 cm upon each lens was repeated 3 times. ◯ is denoted if none of 10 lenses cracks, or × is denoted if more than one lens cracks;

7. light resistance: after irradiation of the optical lens (degree: −6.00) using Q-pannellad products QUV/Spray (5 w) for 200 hours, ◯ is denoted in case of no color change, or × is denoted in case of color change; and

8. demolding property: as provided in embodiment 1, a monomer, an additive and a polymerization initiator were mixed, and then injected into a glass mold by vacuum defoamation. After heating, reinforcing and molding of the lens, ◯ is denoted if the mold is not damaged, or × is denoted if the mold is damaged.

The physical properties obtained from the above embodiments were as follows:

| Physical property | Embodiment 1 | Embodiment 2 | Embodiment 3 | Embodiment 4 |
|---|---|---|---|---|
| Refractivity (nD) | 1.59 | 1.595 | 1.595 | 1.598 |
| Abbe number | 40 | 40 | 41 | 41 |
| Haze | Yes | Yes | No | No |
| Light transmittance (%) | 81 | 87 | 98 | 98 |
| Specific weight | 1.28 | 1.28 | 1.29 | 1.29 |
| Heat resistance | ∘ | ∘ | ∘ | ∘ |
| Bubble | ∘ | ∘ | ∘ | ∘ |
| Impact resistance | ∘ | ∘ | ∘ | ∘ |
| Light resistance | ∘ | ∘ | ∘ | ∘ |
| Demolding property | ∘ | ∘ | ∘ | ∘ |

According to the table, the optical resin composition and optical lens obtained in the present invention have the characteristics of excellent light mass, easy formability, easy dyeability, transparency and high Abbe number. After surface hardening treatment and multi-layer coating (antireflection film spraying), the lens can keep excellent characteristics, and can be applied to all walks of life using the sprayed coatings of a plurality of properties.

In the above chemical name:

Monomer:

IPDI: isocyanate; HMDI: cyanate; PETMP: pentaerythritol tetra(3-mercaptopropionate); PETMA: pentaerythritol tetramethacrylate; XDI: diisocyanate; DBzM: dibenzyl malonate; DAIP: diallyl isophthalate; P-DAIPE: oligomer poly(ethylene glycol isophthalate); CR-39: diallyl 2,2′-oxydiethyl dicarbonate; BMEMP: 1,2-bis(mercaptomethyl)-3-mercaptopropane.

Ultraviolet absorber:

HMBT: 2-(2′-hydroxy-5-methylphenyl)-2H-benzotriazole; HBCBT: 2-(2′-hydroxy-3′,5′-di-tert-butyl-tert-phenyl)-5-chloro-2H-benzotriazole; HBMCBT: 2-(2′-hydroxy-3′-tert-butyl-5′-methylphenyl)-5-chloro-2H-benzotriazole; HAPBT: 2-(2′-hydroxy-3′,5′-di-tert-pentylphenyl-T-)-2H-benzotriazole; HBPBT: 2-(2′-hydroxy-5′-tert-butylphenyl)-2H-benzotriazole; HOPBT: 2-(2′-hydroxy-5′-tert-octylphenol)-2H-benzotriazole; DHBP: dihydroxy-2,4-benzophenone; HMBP:2-hydroxy-4-methoxy chlorobenzophenone; HOOBP: 2-hydroxy-4-octyloxy benzophenone; DOHBP: 4-Dodecyloxy-2-hydroxy benzophenone; BHBP: 4-Benzo-2-hydroxy benzophenone; THBP: 2,2′,4,4′-tetrahydroxy benzophenone; DHMBP: 2,2′-dihydroxy-4,4′-dimethoxy benzophenone; BHMCBT: 2-(3′-tert-butyl-2′-hydroxy-5′-methyl phenyl)-5-chlorophenyltriazole.

Mold release agent:

IPPT: acid isopropyl phosphate; DIPP: acid diisopropyl phosphate; BP: acid butyl phosphate; OP: acid octyl phosphate; DOP: acid diisodecyl phosphate; IDP: inosine diphosphate; DIDP: diisodecyl orthophthalate; TDP: acid tridecyl phosphate; BTDP: acid bistridecyl phosphate.

1% color regulator: 1 g of an organic dye was added to 99 g of toluene (dye dispersed liquid) to prepare 1% mass fraction of color regulator;

HTAQ: 1-hydroxy-4-(p-toluidino)anthraquinone; PRD: Dye (perinone dye); pigment dispersed liquid: BL-1 pigment dispersed liquid of Japanese Tokuyama Corporation.

Polymerization initiator:

BTL: dibutyltin dilaurate; BTC: bis(trichloromethyl) carbonate; BTA: benzotriazole; TEA: triethylamine; IPP: diisopropyl peroxydicarbonate; NPP: diethylhexyl peroxydicarbonate.

The description and application of the invention herein are illustrative and not intended to limit the scope of the invention to the embodiments. Therefore, the invention is not limited to the embodiments, and any technical solution obtained through equivalent substitution falls within the protection scope of the invention.

This patent arises from a U.S. National Stage application of PCT/CN2016/108282, filed Dec. 1, 2016, which claims priority to Chinese Application 201510893873.4, filed Dec. 8, 2015. Both PCT/CN2016/108282 and Chinese Application 201510893873.4 are incorporated herein in their entireties.

What is claimed is:

1. An optical resin composition having high impact resistance, heat resistance and refractivity and obtained by applying organic-inorganic hybrid, wherein the optical resin composition is prepared from the following components by mass percent:

| | |
|---|---|
| Mixture A | 100% |
| Inorganic material | 0.1-5% |
| Ultraviolet absorber | 0.05-6% |
| Mold release agent | 0.01-5% |
| Polymerization initiator | 0.01-5% |
| Color regulator | 0.03-2%; |

wherein the mixture A is obtained by mixing a mixture B and an inorganic material, the inorganic material is 0.1-5% mass percent of the mixture B, and the inorganic material is one of TiO₂, SiO₂ and Zn(OH)₂;
the mixture B is obtained by mixing 30-60% mass percent of a mixture C and 40-70% mass percent of a mixture D;
the mixture C is obtained by mixing isocyanate, cyanate and hydrogenated diphenylmethane diisocyanate, or any two thereof, wherein the molar ratio of the isocyanate to the cyanate is 1:0.3, the molar ratio of the isocyanate to the hydrogenated diphenylmethane diisocyanate is 1:0.4, and the molar ratio of the hydrogenated diphenylmethane diisocyanate to the cyanate is 1:(0.1-0.5);
the mixture D is obtained by mixing pentaerythritol tetra(3-mercaptopropionate) and 2,3-bisthio(2-mercapto)-1-propanethiol, wherein the molar ratio of the pentaerythritol tetra(3-mercaptopropionate) to the 2,3-bisthio(2-mercapto)-1-propanethiol is (0.3-1):1;
the ultraviolet absorber is one of 2-(2′-hydroxy-5-methylphenyl)-2H-benzotriazole, 2-(2′-hydroxy-3′,5′-di-tert-butyl-phenyl)-5-chloro-2H-benzotriazole, 2-(2′-hydroxy-3′-tert-butyl-5′-methylphenyl)-5-chloro-2H-benzotriazole, 2-(2′-hydroxy-3′,5′-di-tert-pentylphenyl-T-)-2H-benzotriazole, 2-(2′-hydroxy-3′,5′-di-tert-butyl-tert-phenyl)-2H-benzotriazole, 2-(2′-hydroxy-5′-tert-butylphenyl)-2H-benzotriazole, 2-(2′-hydroxy-5′-tert-octylphenol)-2H-benzotriazole, 2,4-dihydroxy benzophenone, 2-hydroxy-4-methoxy benzophenone, 2-hydroxy-4-octyloxy benzophenone, 4-dodecyloxy-2-hydroxy benzophenone, 2,2′,4,4′-tetra hydroxy benzophenone, 2,2′,4,4′-tetrahydroxy benzophenone, and 2,2′-dihydroxy-4,4′-dimethoxy benzophenone;
the mold release agent is an acid phosphate, wherein the acid phosphate comprises acid isopropyl phosphate, acid diisopropyl phosphate, acid butyl phosphate, acid octyl phosphate, acid diisodecyl phosphate, acid tridecyl phosphate and acid bistridecyl phosphate; and
the polymerization initiator is a tin-based chemical product having an amino group, and the tin-based compound comprises dibutyltin dilaurate, bis(trichloromethyl) carbonate, benzotriazole; stannous octoate, dibutyltin dilaurate, stannic fluoride, stannic chloride, stannic bromide, stannic iodide, methyltin trichloride, butyltin trichloride, dimethyltin dichloride, dibutyltin dichloride, trimethyltin chloride, tributyltin chloride, triphenyltin chloride and dibutyltin sulfide.

2. The optical resin composition having high impact resistance, heat resistance and refractivity and obtained by applying organic-inorganic hybrid according to claim 1, wherein the molar ratio of the hydrogenated diphenylmethane diisocyanate to the cyanate is preferably 1:(0.2-0.4).

3. The optical resin composition having high impact resistance, heat resistance and refractivity and obtained by applying organic-inorganic hybrid according to claim 1, wherein the liquid phase viscosity of the optical resin composition at 20° C. is 15 to 180 cps.

4. A preparation method of the optical resin composition having high impact resistance, heat resistance and refractivity and obtained by applying organic-inorganic hybrid according to claim 1, comprising the follows steps:
obtaining a mixture B by mixing 30-60% mass percent of a mixture C and 40-70% mass percent of a mixture D in a nitrogen-filled reactor; obtaining a mixture A by adding an inorganic material (0.1-5% mass percent of the mixture B); adding an ultraviolet absorber (0.05-6% mass percent of the mixture D), a mold release agent (0.01-5%), a polymerization initiator (0.01-5%) and a color regulator (0.03-2%); stirring under reduced pressure for 2-5 hours; and terminating the reaction and defoaming under reduced pressure.

5. The optical resin composition having high impact resistance, heat resistance and refractivity and obtained by applying organic-inorganic hybrid according to claim 1, applicable to the preparation of optimal resin lenses, wherein the preparation method thereof comprises the following steps:
injecting the optical resin composition into a mold and putting in a drying oven at a controlled temperature of 33-37° C. for 2 hours; heating to 38-42° C. in 5 hours, heating to 115-130° C. in 12 hours and keeping at this temperature for 2 hours; cooling to 60-80° C. in 2 hours; removing the mold; carrying out thermal treatment at 105-135° C. for 1.5-3 hours; and carrying out hardening treatment and multi-layer coating treatment.
